(19) United States
(12) Patent Application Publication
(10) Pub. No.: US 2013/0111701 A1
(43) Pub. Date: May 9, 2013

(54) Hinge With Deceleration Device For Furniture

(71) Applicant: ARTURO SALICE S.P.A., Novedrate (COMO) (IT)

(72) Inventor: Luciano Salice, Carimate (COMO) (IT)

(73) Assignee: ARTURO SALICE S.P.A., Novedrate (COMO) (IT)

(21) Appl. No.: 13/651,728

(22) Filed: Oct. 15, 2012

(30) Foreign Application Priority Data
Nov. 9, 2011 (IT) MI2011A002035

(51) Int. Cl. E05F 3/20

(52) U.S. Cl. CPC E05F 3/20
USPC 16/50

(57) ABSTRACT

A hinge for furniture has an arm fixable to a fixed part of a piece of furniture and a box fixable to a door of the piece of furniture, the box connected in swinging fashion to the fixing arm. The hinge includes at least one rotation-type deceleration device located on an outer side of a respective side wall of the box, the device having an actuating member located on an inner side of the side wall and a drive element on the fixing arm, the drive element being engageable with the actuating member. The actuating member has a contact cam for contacting the drive element, the contact cam having a profile conformed for causing a rotation of the actuating member of the decelerating device at least in the final part of the closing movement of the door.

### RELATED APPLICATIONS

This application claims benefit of priority under 35 USC §119 of Italy Patent Application No. MI2011A 002035, filed Nov. 9, 2011, entitled “Hinge with Deceleration Device for Furniture,” which application is incorporated herein by reference.

### FIELD OF THE INVENTION

The present invention relates generally to the field of hinges, and more particularly to hinges for furniture, the hinge having a deceleration device.

### BACKGROUND OF THE INVENTION

The present invention concerns a decelerated hinge for doors for furniture, particularly suitable for being configured as a hinge for pieces of furniture which are provided with a front frame to which the hinges themselves are fixed.

In the field of furniture, the use is known of hinges for supporting doors of pieces of furniture in swinging fashion, the hinges comprising a fixed part connectable to the body of the piece of furniture and a movable part, consisting of a box, connectable to the door.

In the case of pieces of furniture with a front frame for fixing the hinges, the hinges themselves generally require the box to be connected to an arm of the fixed part by means of a single articulation pin.

In order to control and slow down the movement of the door in proximity to its closed position, the hinges can be provided with a suitable deceleration device, which, in the case of hinges for pieces of furniture with a front frame for fixing the hinges, is usually positioned inside the box of the hinge, with complex and expensive solutions, because of the difficulty in effectively exploiting the relative movement of the box and the arm of the fixed part for activating the decelerator inside the box.

Furthermore, in some types of hinges, positioning the deceleration device inside the box is sometimes impossible, due to the overall dimensions of the functional parts of the hinge, such as, for example, specific types of closing spring which are placed inside the box itself.

There is therefore a need to have available a hinge of the type under consideration, equipped with a deceleration device which entails limited overall dimensions, and which requires a minimum number of components located inside the box, while being capable of exercising a high decelerating action.

Furthermore, there is a need to have available a hinge with a deceleration device configured so as to be able to exercise a decelerating action that can be modulated along the swinging arc of the door and is adjustable to suit the weight, depending on the dimensional characteristics of the door itself.

### SUMMARY OF THE INVENTION

Embodiments of the present invention will be seen variously to provide a hinge with deceleration device for doors of pieces of furniture, in particular for pieces of furniture with a front frame for fixing the hinges, which is simple to construct and of limited overall dimensions, and which is capable of exercising a high decelerating action.

Further, the present invention provides a hinge of the type under consideration, which allows the decelerating action along the swinging arc of the door to be defined in modulable fashion at the construction stage, and allows the decelerating action to be adjusted at the application stage depending on the weight characteristics of the door.

The above is achievable by providing a hinge for furniture, the hinge comprising an arm for fixing to a fixed part of the piece of furniture, a box for fixing to a door of the piece of furniture, the box being connected in swinging fashion to said fixing arm. The hinge has at least one rotation-type deceleration device located on an outer side of a respective lateral wall of the box, the device presenting an actuating member located on an inner side of the lateral wall, and a drive element on the fixing arm, or on an element connected thereto, engageable with the actuating member of the deceleration device at least during a final part of the closing movement of the door. The actuating member has a contact cam that contacts the drive element, the contact cam having a profile conformed to cause a rotation of the actuating member of the deceleration device at least in the final part of the closing movement of the door.

Further characteristics of the present invention are defined, furthermore, in the claims which follow.

### BRIEF DESCRIPTION OF THE DRAWINGS

The characteristics and advantages of the present invention will become clearer from the following description of preferential but not limiting embodiments of the hinge with deceleration device for pieces of furniture, with reference to the attached drawings, in which:

FIG. 1 is a perspective view of the hinge according to a first embodiment of the invention;

FIG. 2 is an enlarged front view of the actuating member of the deceleration device;

FIG. 3 is a view in transverse section of the hinge of FIG. 1 along line 3-3;

FIG. 4 is a side view of the hinge of FIG. 1 with the box sectioned, in which the hinge is represented in the open position;

FIG. 5 is the side view of the hinge of FIG. 4, in which the hinge is represented in a position of partial closure, in which the drive element is in a condition of initial engagement with the actuating member for the decelerator;

FIG. 6 is the side view of the hinge of FIG. 4, in which the hinge is represented in the closed position;

FIG. 7 is a perspective view of the hinge in accordance with a second embodiment of the invention;

FIG. 8 is a plan view of the hinge of FIG. 7, partially sectioned;

FIG. 9 is a plan view, partially sectioned, of a variant of the hinge of FIG. 8, provided with a system for adjusting the decelerating action, in a configuration of maximum deceleration;

FIG. 10 is a plan view corresponding to the hinge of FIG. 9, in a configuration adjusted in such a way as to exclude the deceleration effect; and

FIG. 11 is a view in longitudinal section of the hinge of FIG. 9 along the line 11-11.

### DETAILED DESCRIPTION OF THE ILLUSTRATED EMBODIMENTS

The hinge with deceleration device according to the present invention, comprehensively indicated by reference number 10, is illustrated in the attached drawings in the form of a hinge applicable to furniture of American type provided with a front frame 11 onto which the hinges are fixed.

This type of hinge 10 in general comprises an arm 12 for fixing the hinge itself to the front frame 11 of the piece of furniture, and a box 13 for fixing to a door of the piece of furniture, not illustrated.

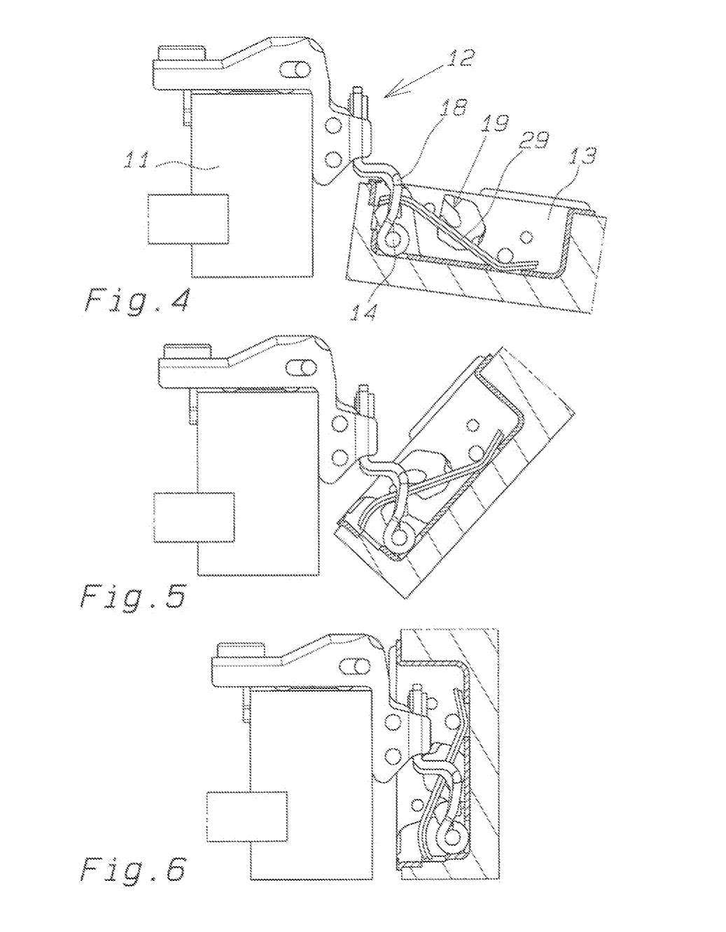

As is better illustrated in FIG. 4, box 13 is connected in swinging fashion to the fixing arm 12 by means of a swinging pin 14 which extends transversely with respect to the longitudinal axis of the fixing arm 12, in such a way that the box 13 can rotate between an open position of the door, illustrated in FIG. 4 itself, and a closed position of the door, illustrated in FIG. 6, under the action of a closure spring 29 of known type, for example housed in box 13.

It is not excluded, however, that the hinge according to the present invention may be of different type, for example of the type applicable to furniture of European type without a front frame for fixing the hinges; in this case the hinge comprises a fixing arm, anchorable to a side wall of the body of the piece of furniture, and a fixing box for fixing to the door of the piece of furniture, which are connected to each other in swinging fashion by means of a first and a second rocker hinged to the arm and to the fixing box by means of four respective swinging pins.

The hinge 10 illustrated comprises likewise at least one rotation-type deceleration device 15 located on an outer side of a respective side wall 16 of the box 13, which has an actuating member 17, located on an inner side of the side wall 16 itself, with which a drive element 18 is engageable, located on the fixing arm 12, or on an element connected thereto, for example one of the rockers mentioned above, during the final part of the closing movement of the door.

The deceleration device 15 and the actuating member 17 thereof have an axis of rotation arranged parallel to the axis of the swinging pin 14, as well as to a bottom wall 13′ of the box 13.

The drive element 18, preferentially in the form of a lateral projection or tooth, projects on one side of the fixing arm 12 which faces towards the actuating member 17 of the deceleration device 15; the drive element 18 is obtained simply from the constructional point of view, by forming it in one piece with the fixing arm 12 or making it as a separate part simply fixed to the arm 12 itself, as explained earlier.

According to the present invention, the actuating member 17 has a cam 19 for contacting the drive element 18, which has a profile shaped so as to cause a rotation of the actuating member 17 of the deceleration device 15 at least in the final part of the closing movement of the door; in this way it is possible at the design and construction stages to define the most appropriate profile for the cam 19 in order to vary the law of movement generated by the actuating member 17 and therefore the operation of the deceleration device 15 connected thereto, thus making it possible simply to modulate the braking action of the deceleration device depending on the specific application.

Preferentially, the profile of the cam 19 is defined by shaped surfaces 20′, 20″ formed in an elongated cavity 21 of the actuating member 17, in which the cavity 21 has an axis of extension substantially offset with respect to the axis of rotation of the actuating member 17, with an opening 21′ which opens towards the drive element 18 to allow the drive element 18 to penetrate into the cavity 21.

In particular, the actuating member 17 is preferentially fork-shaped having a first 17′ and a second 17″ arm which extend spaced apart and coplanar with each other orthogonally to the axis of rotation of the actuating member 17 so as to define between them the said cavity 21, said first arm 17′ being arranged adjacent to the bottom wall 13′ of the box 13, and the opening 21′ of the cavity 21 facing towards the drive element 18; the surfaces 20′, 20″ of the cam 19 are in this case formed on respective stretches of the arms 17′, 17″ of the actuating member 17.

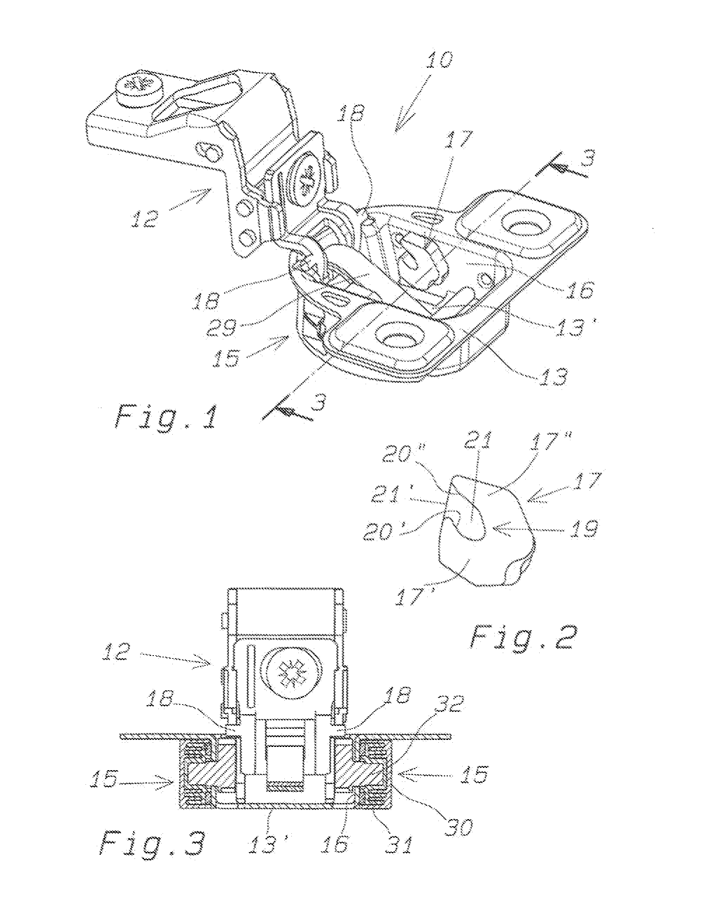

In the embodiment illustrated in FIG. 2, the cam 19 is preferentially formed from a first 20′ and a second 20″ surface part which extend with a U-shaped arrangement respectively over opposed stretches of the arms 17′, 17″ of the actuating member 17; the surfaces 20′. 20″ in the case illustrated have a curved shape with the respective concavities facing each other.

It is not excluded, however, that the surfaces of the cam may have a different conformation, depending on the constructional and functional needs of the hinge.

Thanks to this configuration, the drive element 18, during the final part of the closing movement of the door, comes into contact with the first surface 20′ formed on the first arm 17′, causing a rotation of the actuating member 17 of the deceleration device 15, such as to allow the deceleration device 15 itself to generate the necessary braking action for the door, as illustrated in FIGS. 5 and 6.

The second surface 20″ is however actuated by the drive element 18 during the first part of the opening movement of the door to bring the actuating member 17 of the deceleration device 15 into the initial position illustrated in FIG. 4; in this way, the hinge has great constructional simplicity since it does not require a complicated return system of freewheel type for the deceleration device.

The hinge according to the present invention can be provided with a single deceleration device, or, as in the attached drawings, can preferentially have two deceleration devices 15 arranged symmetrically on opposite side walls 16 of the box 13; in the latter case, for each deceleration device 15 respective actuating members 17 are provided, arranged on facing inner sides of the side walls 16 of the box 13, engageable with corresponding drive elements 18, respectively arranged on opposite sides of the fixing arm 12.

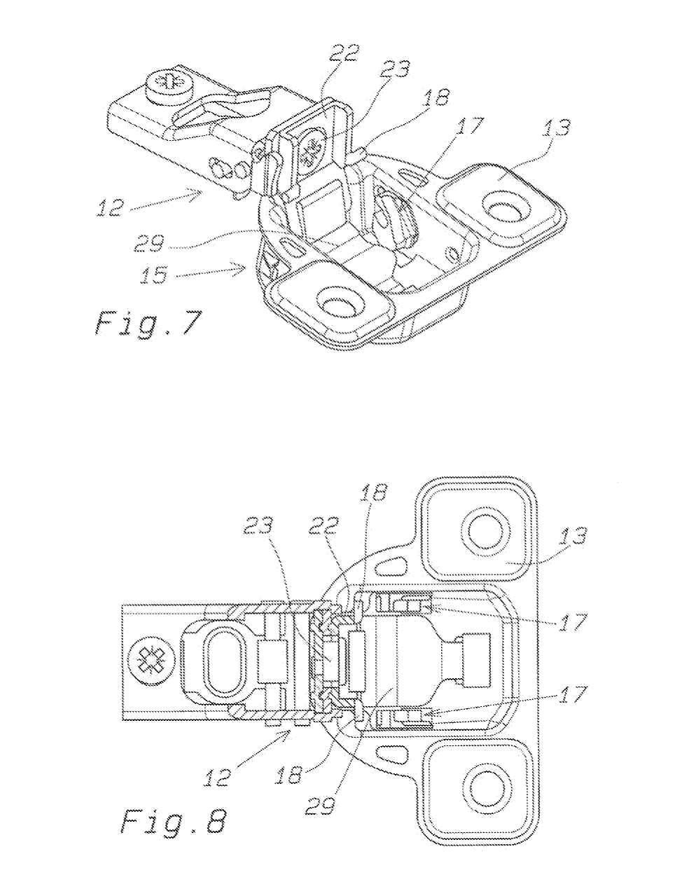

In the embodiment illustrated in FIGS. 1 to 6, the drive elements 18 are formed by shearing in a single piece with the fixing arm 12, while in the embodiment illustrated in FIGS. 7 and 8, the drive element 18 are formed on a separate plate 22 fixed to the arm 12 for example by means of the eccentric 23 for lateral adjustment of the hinge 10, of generally known form, and therefore not described in greater detail.

It is not excluded that the drive elements 18 may be arranged asymmetrically on the sides of the fixing arm 12 and that the profiles of the cams 19 of the actuating members 17 on the two sides of the box 13 are correspondingly shaped so as to engage with the drive element 18 themselves selectively and/or at different successive angular positions of the hinge, in order to obtain specific modulated braking actions.

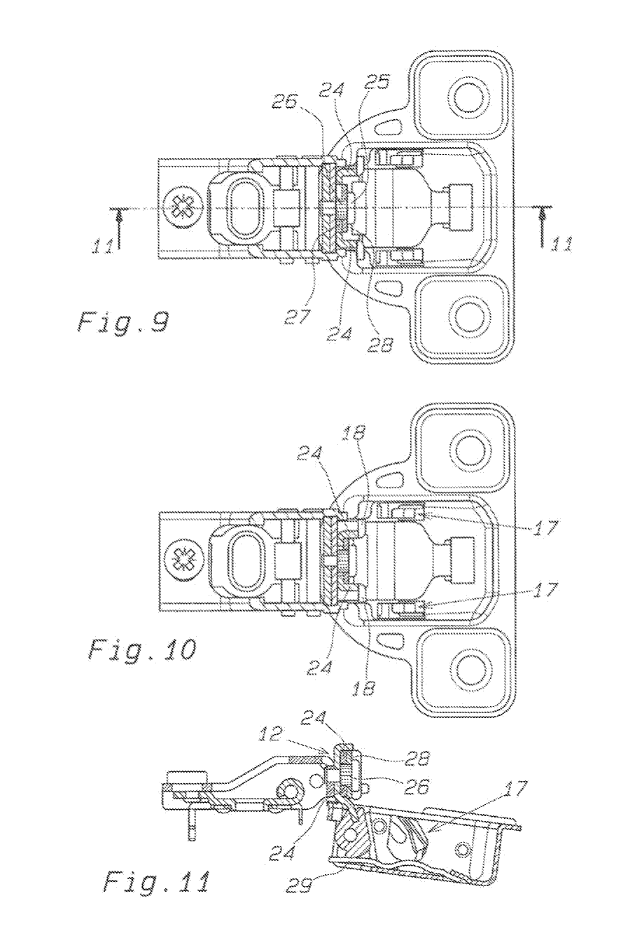

FIGS. 9 to 11 illustrate a variant of the hinge of FIG. 8, provided with a system for adjusting the decelerating action; in this case, the drive elements 18 are formed on wings 24 supported on the fixing arm 12 laterally slidable between the arm 12 and a stop plate 28.

For laterally moving the drive elements 18 which are solid with the wings 24, adjustment means are provided in the form, for example, of a pin fixed onto the arm 12 in rotatable but not axially displaceable manner, provided with a head 25 with a screwdriver slot, and with a toothed part 26 located under the head 25 and engageable with corresponding teeth 27, formed on the wings 24; as a result of these adjustment means, the drive elements 18 are movable between a completely extracted configuration, illustrated in FIG. 9, in which the drive elements 18 activate both the deceleration devices 15 to generate the maximum deceleration, and a completely contracted configuration, illustrated in FIG. 10, in which the drive elements 18 do not activate the deceleration devices 15, thus excluding the deceleration effect.

It is not excluded, however, that the hinge 10 can provide different systems for adjusting the decelerating action, for example a system which provides individual or separate adjustment of the drive elements 18 or means for continuously adjusting the braking action.

As illustrated in FIG. 3, each decelerating device 15 preferentially comprises an outer body 30 for housing a rotatable rotor 31, having a central seat engaging with a shaped pin 32 for the actuating member 17; between the housing body 30 and the rotor 31 a viscous fluid is arranged, for example a highly viscous grease. In order to generate a high braking action the rotor 31 has a plurality of cylindrical friction surfaces which engage and cooperate with corresponding cylindrical friction surfaces 30 by means of the viscous fluid interposed between the surfaces themselves.

The hinge with deceleration device according to the invention is susceptible of modifications and variants falling within the scope of the inventive concept; all the construction details are replaceable by technically equivalent elements.

1. Hinge for furniture comprising:
a fixing arm configured for attachment to a fixed part of the furniture;
a fixing box configured for attachment to a door of the furniture, the fixing box being swingably connected to the fixing arm;
at least one rotational-type deceleration device arranged on an outer side of a respective side wall of the fixing box, each deceleration device having an actuating member arranged on an inner side of the side wall of the fixing box; and
at least one drive element on the fixing arm, or on an element connected to the fixing arm, each drive element being engagable with a respective actuating member of the at least one deceleration device during at least a final part of a closing movement of the door, wherein each actuating member has a contact cam that contacts a drive element during the closing movement of the door, each contact cam having a contour conformed to cause a rotation of the actuating member of the deceleration device at least in correspondence with the final part of the closing movement of the door.

2. The hinge of claim 1, wherein the fixing arm is configured for fixable attachment to a front frame of the furniture, and wherein the fixing arm is swingably connected to the fixing box by a swinging pin.

3. The hinge of claim 1, wherein the drive element protrudes from a side of the fixing arm facing the actuating member of the deceleration device.

4. The hinge of claim 1, wherein the contour of the contact cam includes a first shaped surface actuatable by the drive element during the final part of the closing movement of the door, and a second shaped surface distinct from the first shaped surface, the second shaped surface actuatable by the drive element during an initial part of the opening movement of the door to return the deceleration device.

5. The hinge of claim 1, wherein the contour of the contact cam is defined by at least two shaped surfaces within an elongated cavity of the actuating member, the elongated cavity having an extension axis substantially offset with respect to the rotational axis of the actuating member, the elongated cavity having an opening facing toward the drive element.

6. The hinge of claim 5, wherein the actuating member is fork-shaped having a first and a second arm extending spaced apart and coplanar with each other orthogonally to the rotational axis of the actuating member to define a cavity therebetween, the first arm being arranged adjacent to a bottom wall of the fixing box, wherein the at least two shaped surfaces of the contact cam are formed on respective parts of the first and the second arms of the actuating member.

7. The hinge of claim 6, wherein the at least two shaped surfaces of the contact cam are a first and a second surface part extending with a U-shape respectively on opposing parts of the first and the second arms of the actuating member.

8. The hinge of claim 7, wherein the first and the second surface parts each have a curved shape and each have respective concavities facing each other.

9. The hinge of claim 1, comprising a first and a second deceleration device symmetrically arranged on opposite side walls of the fixing box, each deceleration device provided with a respective actuating member and a corresponding drive element on opposite sides of the hinge.

10. The hinge of claim 9, wherein each drive element is made in one-piece with the fixing arm.

11. The hinge of claim 9, wherein each drive element is formed on a plate separate from the fixing arm.

12. The hinge of claim 9, wherein each drive element is formed on a connecting rocker between the fixing arm and the fixing box.

13. The hinge of claim 9, wherein each drive element is formed on laterally sliding wings, the wings being movable between a wholly extracted configuration and a wholly contracted configuration by an adjusting system.

14. The hinge of claim 9, wherein each deceleration device includes an outer body housing a rotatable rotor connected to the actuating member, the rotatable rotor having a plurality of concentric cylindrical friction surfaces engaged and cooperating with corresponding cylindrical friction surfaces of the outer body via viscous fluid interposed between the respective cylindrical friction surfaces.

15. The hinge of claim 1, further comprising an adjusting system for adjusting the decelerating action of the deceleration device of the hinge.

16. The hinge of claim 1, wherein the drive element is made in one-piece with the fixing arm.

17. The hinge of claim 1, wherein the drive element is formed on a plate separate from the fixing arm.

18. The hinge of claim 1, wherein the drive element is formed on a connecting rocker between the fixing arm and the fixing box.

19. The hinge of claim 1, wherein the drive element is formed on a laterally sliding wing, the wing being movable between a wholly extracted configuration and a wholly contracted configuration by an adjusting system.

20. The hinge of claim 1, wherein the deceleration device includes an outer body housing a rotatable rotor connected to the actuating member, the rotatable rotor having a plurality of concentric cylindrical friction surfaces engaged and cooperating with corresponding cylindrical friction surfaces of the outer body via viscous fluid interposed between the respective cylindrical friction surfaces.
